(19) United States
(12) Patent Application Publication
(10) Pub. No.: US 2013/0212944 A1
(43) Pub. Date: Aug. 22, 2013

(54) CATALYTIC PURIFICATION OF GASES

(71) Applicants: Hazel Stephenson, Huddersfield (GB); Heather Bradshaw, Bury (GB); Pekka Simell, Vantaa (FI); Anu Solla, Winterthur (CH); Ella Ronkkonen, Espoo (FI); Outi Krause, Espoo (FI)

(72) Inventors: Hazel Stephenson, Huddersfield (GB); Heather Bradshaw, Bury (GB); Pekka Simell, Vantaa (FI); Anu Solla, Winterthur (CH); Ella Ronkkonen, Espoo (FI); Outi Krause, Espoo (FI)

(73) Assignees: VALTION TEKNILLINEN TUTKIMUSKESKUS, Espoo (FI); MAGNESIUM ELEKTRON LIMITED, Salford (GB)

(21) Appl. No.: 13/817,513

(22) PCT Filed: Aug. 22, 2011
(86) PCT No.: PCT/GB11/51581

§ 371 Date: Mar. 26, 2013

(30) Foreign Application Priority Data
Aug. 20, 2010 (GB) 1013984.8

(51) Int. Cl. C10K 3/02; B01J 21/06

(52) U.S. Cl. CPC C10K 3/023; B01J 21/066
USPC 48/111; 48/89; 48/127.7; 502/349; 502/304; 502/303

(57) ABSTRACT

A zirconium-based mixed oxide or zirconium-based mixed hydroxide which is capable of (a) at least 90% v/v conversion of naphthalene at atmospheric pressure at a temperature in the range 600-700° C. using a residence time of about 0.3 seconds, and/or (b) providing an initial heat of adsorption of ammonia of greater than 150 kJ/mol when measured by ammonia flowing gas microcalorimetry. Also, a method for purifying gas produced from the gasification of carbonaceous materials, comprising the step of bringing the gas into contact with such mixed oxides or mixed hydroxides.

This invention relates to the catalytic purification of gases formed, for example, by the gasification of carbonaceous materials, such as a fossil fuel or wood.

Such gasification processes are designed to generate combustible gases such as carbon monoxide, methane and hydrogen, but often they yield a gas stream containing unwanted heavier hydrocarbons, commonly referred to as tars, and ammonia. It is known to purify this gas stream by passing the stream over a catalyst in order to remove these tars and ammonia by oxidative decomposition, but there is a need for a catalyst system which is capable of decomposing both tars and ammonia with higher activity at lower temperatures than is currently possible with available catalysts, particularly when the gas stream to be purified is contaminated with sulphur compounds, such as hydrogen sulphide.

### BACKGROUND TO THE INVENTION

EP 1404785 describes a method for the purification of gasification gas using a zirconium based catalyst, preferably zirconia. Although an operating temperature range of 500-900° C. is described it has been found that the best performance for a zirconia catalyst is achieved at about 700° C. The work to develop this catalyst has been mainly focused on monolith types of catalysts where the zirconia catalyst is washcoated onto a ceramic monolith support. Zirconia catalysts operate in such a way that the condensable heavy tar fraction in the gas stream is decomposed to gases, whilst the light tars, like toluene, are not affected so much. Thus these known zirconia catalysts are suitable for processes where heavy tars are problematic, such as in the utilisation of gas in gas engines.

These zirconia catalysts can also be used as pre-reforming catalysts to enhance the operation of deep reforming catalysts, for example using nickel or precious metal catalysts, in the production of synthesis gas, as described in WO 2007/116121.

### BRIEF DESCRIPTION OF THE INVENTION

The present invention generally relates to a gas stream purification process such as the type described above in EP 1404785 in which in place of the known catalysts based solely on zirconium an improved catalyst is used.

More specifically, this invention relates to a zirconium-based mixed oxide or a zirconium-based mixed hydroxide which is capable of (a) at least 90% v/v conversion of naphthalene at atmospheric pressure at a temperature in the range 600-700° C. using a residence time of about 0.3 seconds, and/or (b) providing an initial heat of adsorption of ammonia of greater than 150 kJ/mol when measured by ammonia flowing gas microcalorimetry. The phrase “initial heat of adsorption” is used to refer to heat of adsorption of the first pulse of ammonia passed over the mixed oxide/hydroxide using ammonia flowing gas microcalorimetry. In some embodiments, the above naphthalene conversion is provided at a temperature in the range 650-700° C. In some embodiments, the conversion is at least 95% v/v. The conversion of naphthalene is preferably by oxidative decomposition, normally to one or more of CO, CO₂ and H₂O. The term “residence time” refers to the time that the naphthalene is in contact with the mixed oxide/hydroxide in a closed chamber (ie a reactor).

In some embodiments the mixed oxide or mixed hydroxide, after hydrothermal treatment in 70% v/v steam in nitrogen at 700° C. for 85 hours, is capable of at least 90% v/v conversion of naphthalene at atmospheric pressure at a temperature in the range 600-700° C. using a residence time of about 0.3 seconds. Preferably, the above naphthalene conversion is provided at a temperature in the range 650-700° C.

It is preferred that the initial heat of adsorption of ammonia is at least 160 kJ/mol, more preferably at least 180 kJ/mol. The initial heat of adsorption of ammonia is thought to be an indication of the number of Lewis acid sites on the surface of the mixed oxide or mixed hydroxide. In some embodiments, the mixed oxide or mixed hydroxide is capable of, after calcination at 800° C. for 2 hours, a surface coverage of CO₂ of at least 0.02 mmol/gram, preferably at least 0.03 mmol/gram, at 200° C. as measured by CO₂ temperature programmed desorption. In some embodiments, the mixed oxide or mixed hydroxide is capable of, after calcination at 800° C. for 2 hours, a surface coverage of CO₂ of at least 0.05 mmol/gram, preferably at least 0.06 mmol/gram, at 800° C. as measured by CO₂ temperature programmed desorption. This surface coverage is thought to correspond to the number of Lewis base sites on the surface of the mixed oxide or mixed hydroxide.

Without wishing to be bound to any theory, it is thought that the mixed oxides and mixed hydroxides of the invention provide improved properties (such as improved naphthalene conversion and improved ammonia and carbon dioxide adsorption) due to an increased number of Lewis acid and Lewis base sites on the surface of the mixed oxide/hydroxide. It is also thought that increased strength of these sites provides further improvements. The Lewis acid sites are thought to adsorb ammonia, whilst the Lewis base sites are thought to adsorb carbon dioxide.

Preferably, the mixed oxide or mixed hydroxide has a surface area greater than 50 m²/g after calcination at 800° C., more preferably greater than 70 m²/g, even more preferably greater than 80 m²/g. Preferably, the mixed oxide or mixed hydroxide has a total pore volume as measured by nitrogen porosimetry of greater than 0.1 cm³/g but less than 1.0 cm³/g after calcination at 800° C. for 2 hours, more preferably at least 0.25 cm³/g, even more preferably at least 0.40 cm³/g. It is preferred that the mixed oxide or mixed hydroxide has a total pore volume as measured by nitrogen porosimetry of greater than 0.1 cm³/g but less than 1.0 cm³/g after calcination at 1000° C. for 2 hours, more preferably at least 0.15 cm³/g, even more preferably at least 0.25 cm³/g.

It is preferred that the mixed oxide or mixed hydroxide additionally comprises cerium, silicon or lanthanum, preferably cerium or lanthanum and more preferably both cerium and lanthanum. The cerium and/or lanthanum may be in their hydroxide form (ie cerium hydroxide and/or lanthanum hydroxide) or their oxide form (ie ceria (CeO₂) and/or lanthana (La₂O₃)). Although catalytically active in their hydroxide form, it is preferred that the oxide form of both the lanthanum and cerium dopants be used. Conveniently these oxides can be formed by calcination of the mixed hydroxide, the optimal calcination temperature being in the range 800-1000° C. The calcination to form the oxides of the the lanthanum and cerium dopants also converts zirconium hydroxide to zirconia (ie zirconium oxide). Thus, although the mixed hydroxides of the invention are catalytically active, the mixed oxides are preferred.

Although the doping of zirconia catalysts to improve their performance is known, it has surprisingly been found that for the purification of a gas stream that contains both tar and ammonia, particularly in the presence of hydrogen sulphide, the zirconia should preferably contain both lanthana and ceria, since the combination of both dopants produces a catalyst that exhibits a performance superior to that of zirconia doped with either lanthana or ceria alone.

In some embodiments, the mixed oxide or mixed hydroxide comprises at least 50 wt % zirconia or zirconium hydroxide. Preferably, the mixed oxide or mixed hydroxide comprises at least 60 wt % zirconia or zirconium hydroxide, more preferably at least 70 wt % zirconia or zirconium hydroxide. In some embodiments, the mixed oxide or mixed hydroxide comprises at least 80 wt % zirconia or zirconium hydroxide.

In some embodiments, the mixed oxide or mixed hydroxide comprises 1-49 wt % ceria or cerium hydroxide. In some embodiments, particularly when the mixed oxide or mixed hydroxide additionally comprises lanthanum, the mixed oxide or mixed hydroxide comprises 10-25 wt % ceria or cerium hydroxide, preferably 12-22 wt % ceria or cerium hydroxide, more preferably 15-19 wt % ceria or cerium hydroxide, even more preferably about 17 wt % ceria or cerium hydroxide. In other embodiments, the mixed oxide or mixed hydroxide comprises 10-30 wt % ceria or cerium hydroxide, preferably 15-25 wt % ceria or cerium hydroxide, more preferably about 20 wt % ceria or cerium hydroxide.

In some embodiments, the mixed oxide or mixed hydroxide comprises 0.5-25 wt % lanthana or lanthanum hydroxide. Preferably, particularly when the mixed oxide or mixed hydroxide additionally comprises cerium, the mixed oxide or mixed hydroxide comprises 1-10 wt % lanthana or lanthanum hydroxide, more preferably 2-8 wt % lanthana or lanthanum hydroxide, even more preferably 4-6 wt % lanthana or lanthanum hydroxide. Most preferably, the mixed oxide or mixed hydroxide comprises about 5 wt % lanthana or lanthanum hydroxide.

In some embodiments, the mixed oxide or mixed hydroxide comprises zirconia or zirconium hydroxide, ceria or cerium hydroxide, and lanthana or lanthanum hydroxide, with the balance being incidental impurities, preferably at a level of less than 5 wt %, more preferably less than 3 wt %, even more preferably less than 2 wt %, in some embodiments less than 1.5 wt %. The incidental impurities may include HfO₂. It is preferred that the mixed oxide or mixed hydroxide comprises (a) at least 60 wt % zirconia and/or zirconium hydroxide, (b) 10-25 wt % ceria and/or cerium hydroxide, and (c) 1-10 wt % lanthana and/or lanthanum hydroxide. More preferably, the mixed oxide or mixed hydroxide comprises at least 70 wt % zirconia and/or zirconium hydroxide, (b) 15-19 wt % ceria and/or cerium hydroxide, and (c) 4-6 wt % lanthana and/or lanthanum hydroxide. A particularly preferred mixed oxide or mixed hydroxide comprises 17 wt % ceria or cerium hydroxide and 5 wt % lanthana, with the balance being zirconia and incidental impurities. The incidental impurities are preferably at a level of less than 5 wt %, more preferably less than 3 wt %, even more preferably less than 2 wt %, in some embodiments less than 1.5 wt %.

Whilst the doping of the zirconia can be effected by intimate mixing of the individual oxides or hydroxides, it is preferred that the doped zirconia used in the present invention be formed as a precipitated mixed hydroxide. Most preferably such a mixed hydroxide can be formed by a process of the type described in WO 03/037506 or WO 2004/096713. Thus, a preferred method of producing the mixed oxides or mixed hydroxides of the invention comprises the steps of (a) reacting an alkali with an aqueous solution of a zirconium salt, optionally in the presence of a cerium salt and/or a lanthanum salt, to form a zirconium hydroxide or a mixed hydroxide, and (b) optionally calcining the hydroxide to form the corresponding oxide. However, additional preparation methods can be used.

The particle size distribution of the mixed oxide or mixed hydroxide should preferably be such that 90 wt % of the particles are less than 15 μm in diameter, more preferably less than 10 μm in diameter, even more preferably less than 5 μm in diameter. Preferably, only 10 wt % of the particles have a diameter of less than 0.4 μm, more preferably less than 0.6 μm even more preferably less than 0.8 μm. The mixed oxides or mixed hydroxides can be precipitated or milled to produce the required particle size distribution, as measure by Laser Diffraction after sonication to disperse agglomerates. The specific partial size, although not thought to be critical for the activity of the material, can be important in the preparation of a material which is in a suitable form for use in commercial applications.

The mixed oxide or mixed hydroxide can be formed as powder, shaped particles or as a coating on a ceramic or metal substrate.

The mixed oxides and mixed hydroxides of the present invention preferably have the following characteristic features that are different from previously known catalysts used for the removal of tars and ammonia by oxidative decomposition:

They have higher tar decomposing activity at 600-800° C. in gas atmospheres that contain the impurities typically present in gasification gases, such as H₂S. It is preferred that the mixed oxide or mixed hydroxide provides at least 70% v/v conversion of naphthalene at atmospheric pressure at a temperature above 700° C., preferably at a temperature in the range 700-900° C., more preferably 700-800° C., using a residence time of about 0.3 seconds. Preferably the above naphthalene conversion is provided in the range 700-775° C.

They are thermally and chemically stable and will not deactivate by the typical impurities contained in gasification gases, like sulphur compounds and/or water.

It is preferred that the mixed oxides are heated to a temperature of 700-1000° C. prior to use, more preferably 750-900° C., even more preferably 800-850° C. This heating is may be carried out after calcination (ie after step (b) in the method described above). This process is known as activation. Activation can also be by calcination. The materials exhibit improved properties as measured in the ammonia calorimetry, giving extremely high initial heats of adsorption compared to other mixed oxides, particularly when activated at an appropriate temperature. The values which can be achieved are in the range typically associated with super acids. As discussed above, this is thought to be due to the high concentration of Lewis acid sites. The materials also show improved properties in the carbon dioxide calorimetry, giving high initial heats of adsorption, but also developing improved surface coverage on activation at the afore mentioned appropriate activation temperatures. As discussed above this is thought to be due to the high concentration of Lewis base sites.

This invention also relates to a plant for the gasification of carbonaceous materials comprising a mixed oxide or mixed hydroxide as described above. Preferably, the mixed oxide or mixed hydroxide is positioned within a gasifier, more preferably such that gasification gas passes over the mixed oxide.

This invention also relates to a method for purifying gas produced from the gasification of carbonaceous materials, comprising the step of bringing the gas into contact with a mixed oxide or mixed hydroxide as described above. The word “purifying” is used in relation to the present invention to mean the removal of impurities. The impurities can include tars (such as hydrocarbons with 5 or more carbon atoms, eg naphthalene) and ammonia. It is preferred that this method provides (a) at least 90% v/v conversion of naphthalene at atmospheric pressure at a temperature in the range 600-700° C. using a residence time of about 0.3 seconds, and/or (b) an initial heat of adsorption of ammonia of greater than 150 kJ/mol when measured by ammonia flowing gas microcalorimetry.

In addition, this invention relates to the use of a mixed oxide or mixed hydroxide as claimed in any one of the preceding claims in the purification of gas produced from the gasification of carbonaceous materials. It is preferred that this use provides (a) at least 90% v/v conversion of naphthalene at atmospheric pressure at a temperature in the range 600-700° C. using a residence time of about 0.3 seconds, and/or (b) an initial heat of adsorption of ammonia of greater than 150 kJ/mol when measured by ammonia flowing gas microcalorimetry.

The present invention will now be described by way of example with reference to the accompanying drawings, in which:

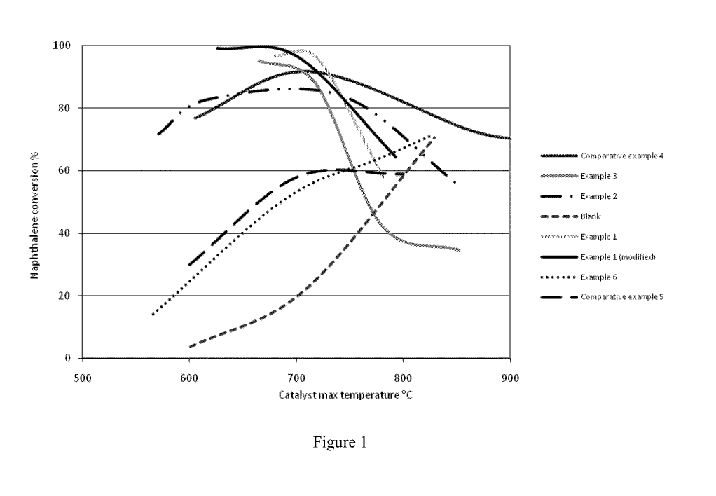

FIG. 1 is a graph showing the percentage conversion of naphthalene using various oxides at different temperatures.

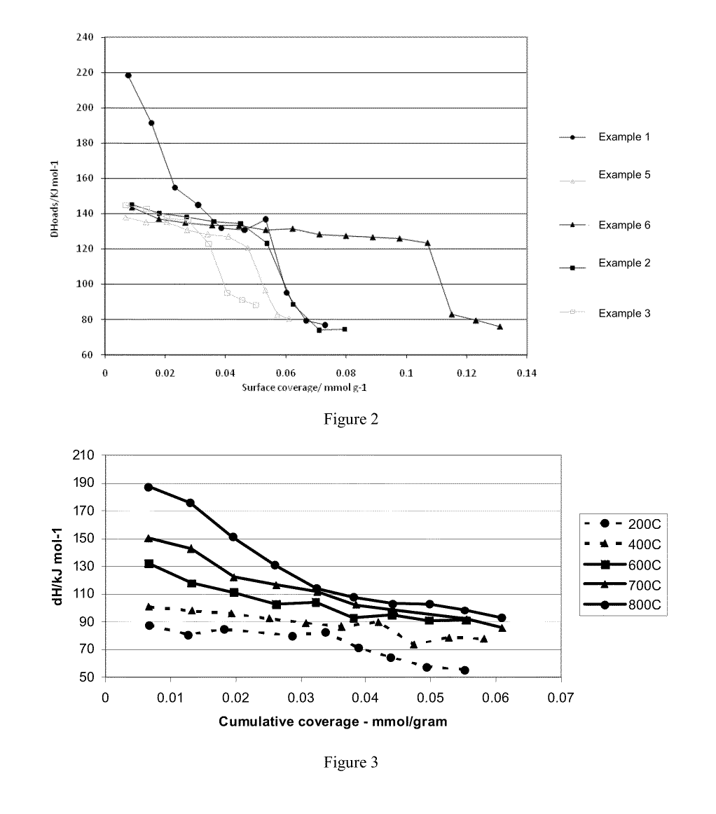

FIG. 2 is a graph showing ammonia calorimetry data for a range of different oxides.

FIG. 3 is a graph showing ammonia calorimetry data for a mixed oxide comprising 17 wt % CeO₂ and 5 wt % La₂O₃ (ie as per Example 1), with the balance being ZrO₂, which was calcined at 800° C. and then activated at a range of temperatures.

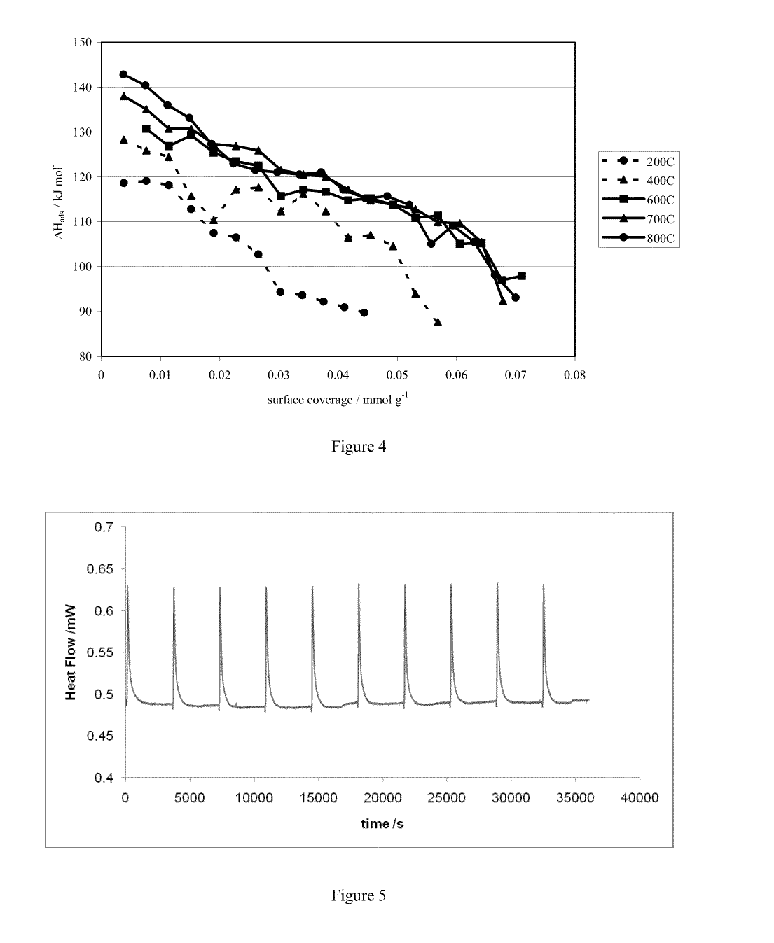

FIG. 4 is a graph showing carbon dioxide calorimetry data for a mixed oxide comprising 17 wt % CeO₂ and 5 wt % La₂O₃ (ie as per Example 1), with the balance being ZrO₂, which was calcined at 800° C. and then activated at (ie heated to) a range of temperatures.

FIG. 5 is a graph showing ammonia calorimetry data for a mixed oxide comprising 17 wt % CeO₂ and 5 wt % La₂O₃ (ie as per Example 1), with the balance being ZrO₂.

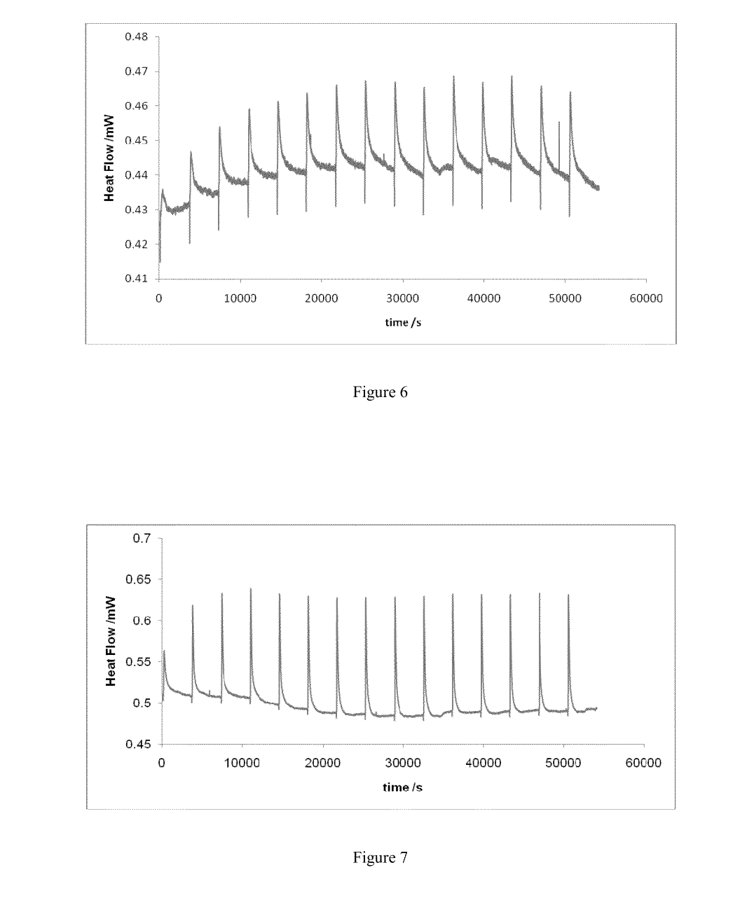

FIG. 6 is a graph showing ammonia calorimetry data for a mixed oxide comprising 3 wt % SiO₂ and 12 wt % La₂O₃ (ie as per Comparative Example 8), with the balance being ZrO₂.

FIG. 7 is a graph showing ammonia calorimetry data for a mixed oxide comprising 3 wt % SiO₂ and 10 wt % La₂O₃ (ie as per Comparative Example 7), with the balance being ZrO₂.

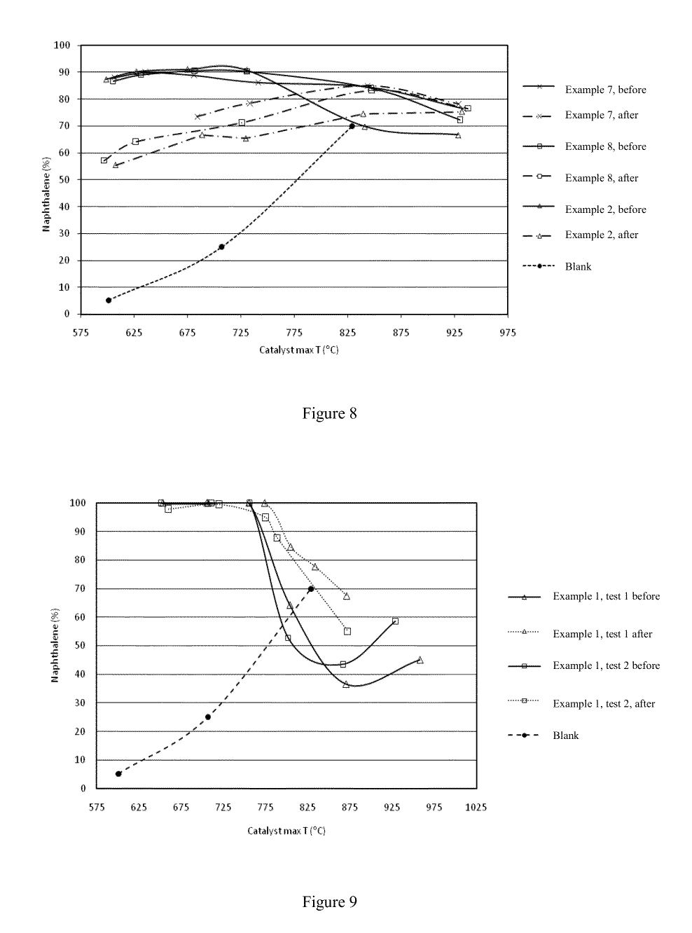

FIG. 8 is a graph showing the percentage conversion of naphthalene for various mixed oxides at different temperatures.

FIG. 9 is a graph showing the percentage conversion of naphthalene for two mixed oxides comprising 17 wt % CeO₂ and 5 wt % La₂O₃ (ie as per Example 1), with the balance being ZrO₂.

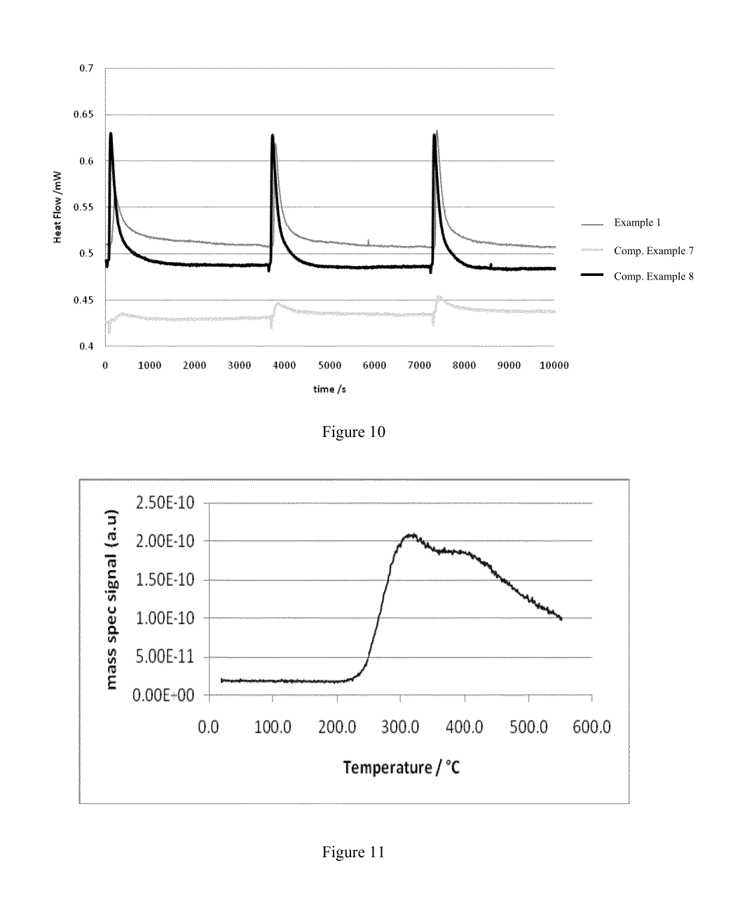

FIG. 10 is a graph showing an overlay of the graphs of FIGS. 5, 6 and 7 over the time range 0-10,000 seconds.

FIG. 11 is a graph showing ammonia temperature programmed desorption (TPD) data for a mixed oxide comprising 17 wt % CeO₂ and 5 wt % La₂O₃ (ie as per Example 1), with the balance being ZrO₂.

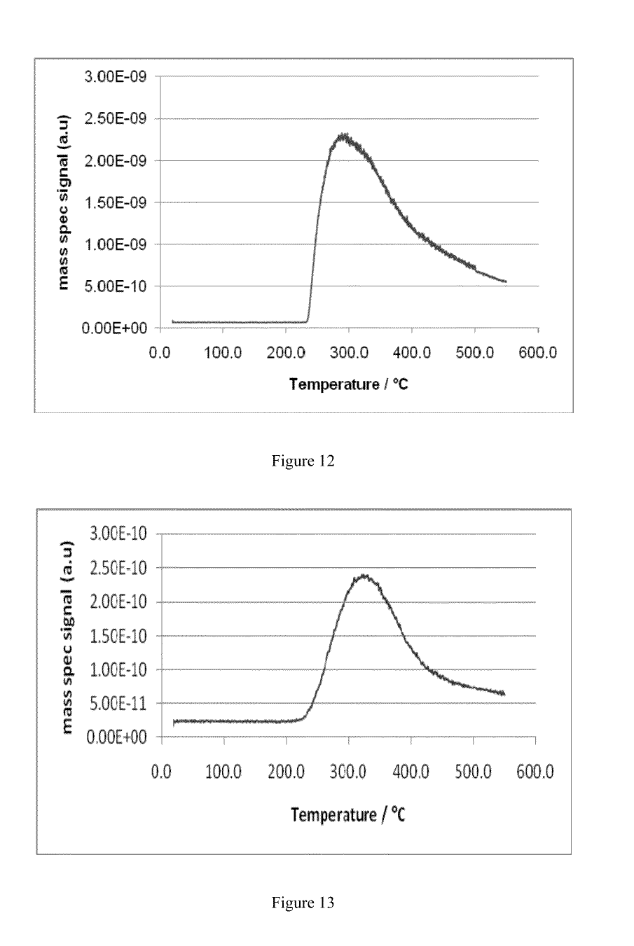

FIG. 12 is a graph showing ammonia TPD data for a mixed oxide comprising 17 wt % CeO₂ and 5 wt % La₂O₃ (ie as per Example 1), with the balance being ZrO₂.

FIG. 13 is a graph showing ammonia TPD data for a mixed oxide comprising 3 wt % SiO₂ and 12 wt % La₂O₃ (ie as per Comparative Example 8), with the balance being ZrO₂.

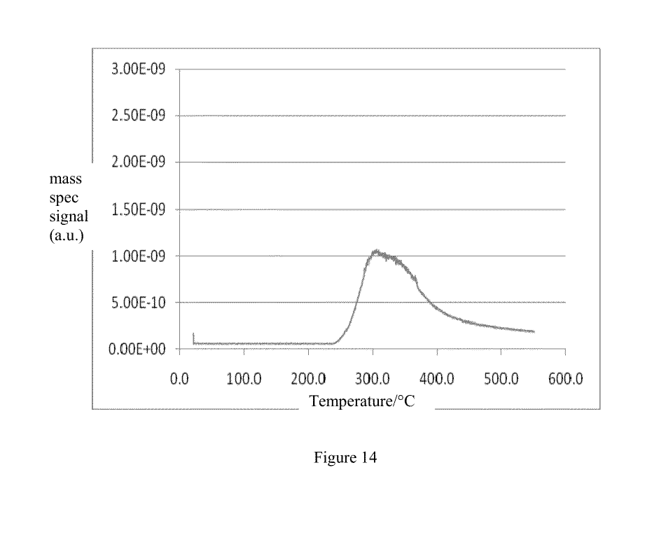

FIG. 14 is a graph showing ammonia TPD data for a mixed oxide comprising 3 wt % SiO₂ and 10 wt % La₂O₃ (ie as per Comparative Example 7), with the balance being ZrO₂.

### EXAMPLES

Samples were Prepared in Accordance with the Methods Described in WO 03/037506 or WO 2004/096713.

### Example 1

### Preparation of a Ce—La—ZrO₂ Catalyst

To a chilled aqueous solution of zirconium oxychloride, cerium nitrate, lanthanum nitrate and sulphuric acid, sodium hydroxide was added to pH >12. With stirring 35% hydrogen peroxide was then added and the resulting precipitate filtered and washed with deionised water in multiple stages to remove residual impurities including Na, Cl and SO₃. The resulting cake was then hydrothermally treated at 3 barg for 3 hours, dried at a temperature of less than 120° C. and then calcined. Two samples were prepared, one calcined at 800° C. and one calcined at 1000° C. This resulted in products with 5 wt % La₂O₃, 17 wt % CeO₂. The sample can be modified by altering the milling conditions to change the particle size.

### Comparative Example 2

### Preparation of a Comparative La—ZrO₂ Catalyst

The method of Example 1 was repeated in the absence of cerium nitrate and hydrogen peroxide. The resulting product contained 10 wt % La₂O₃.

### Example 3

### Preparation of a Ce—ZrO₂ Catalyst

The method of Example 1 was repeated in the absence of lanthanum nitrate and hydrogen peroxide. The resulting product contained 20 wt % CeO₂.

### Comparative Example 4

### Preparation of a Comparative Y—ZrO₂ Catalyst

To a chilled aqueous solution of zirconium oxychloride, yttrium nitrate and sulphuric acid, sodium hydroxide was added to pH >12. The resulting precipitate was then filtered and washed with deionised water in multiple stages to remove residual impurities including Na, Cl and SO₃. The resulting cake was then hydrothermally treated at 1 barg for 1 hour, then dried at <120° C., calcined and milled. Two samples were prepared, one calcined at 800° C. and one calcined at 1000° C. The resulting product contained 20 wt % Y₂O₃.

### Comparative Example 5

### Preparation of a Comparative Undoped ZrO₂ Catalyst

To a chilled aqueous solution of zirconium oxychloride and sulphuric acid, sodium hydroxide was added to pH >12. The resulting precipitate was then filtered and washed with deionised water in multiple stages to remove residual impurities including Na, Cl and SO₃. The resulting cake was then hydrothermally treated at 1 barg for 1 hour, dried, calcined and milled. Two samples were prepared, one calcined at 800° C. and one calcined at 1000° C.

### Comparative Example 6

### Preparation of a Comparative Si—ZrO₂ Catalyst

To a chilled aqueous solution of zirconium oxychloride, and sulphuric acid, sodium hydroxide was added to pH >12. The resulting precipitate filtered and washed with deionised water in multiple stages to remove residual impurities including Na, Cl and SO₃. The resulting cake was reslurried and an aqueous silica sol added. The resulting slurry was then hydrothermally treated at 1 barg for 1 hour, dried then calcined prior to milling to the desired particle size. Two samples were prepared, one calcined at 800° C. and one calcined at 1000° C. This resulted in products with 3.5 wt % SiO₂. The sample can be modified by altering the milling conditions to change the particle size.

### Comparative Example 7

### Preparation of a Comparative La—Si—ZrO₂ Catalyst

To a chilled aqueous solution of zirconium oxychloride, lanthanum nitrate and sulphuric acid, sodium hydroxide was added to pH >12. The resulting precipitate filtered and washed with deionised water in multiple stages to remove residual impurities including Na, Cl and SO₃. The resulting cake was then reslurried and a silica sol was added. The resulting slurry was hydrothermally treated, dried then calcined at 800° C. prior to milling to the desired particle size. This resulted in products with 10 wt % La₂O₃, 3 wt % SiO₂. The sample can be modified by altering the milling conditions to change the particle size.

### Comparative Example 8

### Preparation of a Comparative La—Si—ZrO₂ Catalyst

To a chilled aqueous solution of zirconium oxychloride, lanthanum nitrate and sulphuric acid, sodium hydroxide was added to pH >12. The resulting precipitate was filtered and washed with deionised water in multiple stages to remove residual impurities including Na, Cl and SO₃. The resulting cake was then reslurried, a silica sol added and the resulting mixture hydrothermally treated. The mixture was dried then calcined at 800° C. prior to milling to the desired particle size. This resulted in products with 12 wt % La₂O₃, 3 wt % SiO₂. The sample can be modified by altering the milling conditions to change the particle size.

Characterisation data for the samples produced in the examples are given in Table 1. pHiep stands for pH of isoelectric point. Reslurry pH (DIW) is the pH of the sample when reslurried in deionised water. Reslurry pH (KCl) is the pH of the sample when reslurried in a solution of potassium chloride. LOI stands for loss of ignition.

TABLE 1
Characterisation data for various different compositions of catalysts used in the Examples.

| | Calcination | | | | | Crystallite | | | | | | Total pore |
|---|---|---|---|---|---|---|---|---|---|---|---|---|
| | temperature | Zeta | | Reslurry | Reslurry | size | LOI | d10 | d50 | d90 | Surface area | volume |
| Sample | ° C. | potential | pHiep | pH (DIW) | pH (KCl) | (nm) | (%) | (m) | (m) | (m) | m²/g | cm³/g |
| Comp. | 800 | 9.4 | 8.2 | 9.2 | 7.5 | 8 | 3.9 | 1.5 | 3.8 | 8.0 | 91 | 0.36 |
| Ex. 2 | | | | | | | | | | | | |
| Comp. | 1000 | 10.0 | 10.0 | 9.3 | 9.2 | 11 | 3.0 | 1.3 | 3.5 | 7.6 | 62 | 0.16 |
| Ex. 2 | | | | | | | | | | | | |
| Comp. | 800 | −3.8 | 6.9 | 6.2 | 7.2 | 23 | 1.0 | 1.1 | 2.8 | 5.5 | 27 | 0.22 |
| Ex. 5 | | | | | | | | | | | | |
| Comp. | 1000 | −4.7 | 6.7 | 6.8 | 7.5 | 50 | 0.4 | 1.0 | 2.6 | 5.2 | 9 | 0.02 |
| Ex. 5 | | | | | | | | | | | | |
| Example 1 | 800 | 0.2 | 9.1 | 8.0 | 9.1 | 8 | 1.4 | 1.2 | 2.8 | 4.9 | 93 | 0.42 |
| Example 1 | 1000 | 12.6 | 7.6 | 8.1 | 7.7 | 11 | 1.1 | 1.1 | 2.5 | 4.7 | 56 | 0.31 |
| Comp. | 800 | | | | | | | | | | 54 | 0.20 |
| Ex. 4 | | | | | | | | | | | | |
| Comp. | 1000 | | | | | | | | | | 15 | 0.11 |
| Ex. 4 | | | | | | | | | | | | |
| Comp. | 800 | 3.0 | 5.0 | 5.8 | 5.3 | 7 | 3.8 | 1.3 | 3.8 | 8.8 | 129 | 0.34 |
| Ex. 6 | | | | | | | | | | | | |
| Comp. | 1000 | −16.7 | N/A | 3.8 | 3.3 | 11 | 1.1 | 1.1 | 3.4 | 8.1 | 63 | 0.19 |
| Ex. 4 | | | | | | | | | | | | |

### Experimental Testing—Naphthalene Conversion

The superiority of the catalysts used in the present invention was established as follows:

The catalytic activity of undoped, ceria-lanthanum, lanthanum, yttria and ceria doped zirconium oxides were compared in a laboratory test unit using simulated gasification gas. In these tests washcoated monolith samples were tested at various temperatures in the range 600-900° C. at atmospheric pressure using about 0.3 s residence time. The simulated gas contained all the main components present in real gasification gas in realistic proportions, thus modelling typical gas obtained from a biomass fed fluid bed gasifier. These gases consisted of CO, CO₂, CH₄, H₂, H₂O, NH₃ and H₂S, with a toluene/naphthalene mixture being used as a tar model. In the test naphthalene represents the most problematic condensable tar fraction.

The results of these tests are set out in Table 2 and graphically in FIG. 1.

TABLE 2
Table of data used in FIG. 1.

| | | | | | |
|---|---|---|---|---|---|
| Comp. Ex. 4 - | Catalyst max temperature | 605 | 712 | 865 | 930 |
| Y—ZrO₂ | ° C. | | | | |
| | Naphtalene conversion % | 76.8 | 91.7 | 72.6 | 69.7 |
| Example 3 - | Catalyst max temperature | 665 | 718 | 780 | 852 |
| Ce—ZrO₂ | ° C. | | | | |
| | Naphtalene conversion % | 95 | 88 | 42 | 35 |
| Comp. Ex. 2 - | Catalyst max temperature | 571 | 617 | 742 | 853 |
| La—ZrO₂ | ° C. | | | | |
| | Naphtalene conversion % | 72 | 83 | 84 | 55 |
| Blank (no | Catalyst max temperature | 601 | 707 | 829 | |
| coating) | ° C. | | | | |
| | Naphtalene conversion % | 4 | 22 | 71 | |
| Example 1 - | Catalyst max temperature | 679 | 720 | 782 | |
| Ce—La—ZrO₂ | ° C. | | | | |
| | Naphtalene conversion % | 96.6 | 95.8 | 57.9 | |
| Example 1 - | Catalyst max temperature | 626 | 701 | 793 | |
| Ce—La—ZrO₂ | ° C. | | | | |
| (modified | | | | | |
| particle size) | | | | | |
| | Naphtalene conversion % | 99 | 97 | 64 | |
| Comp. Ex. 6 - | Catalyst max temperature | 566 | 689 | 777 | 828 |
| Si—ZrO₂ | ° C. | | | | |
| | Naphtalene conversion | 14.2 | 51.0 | 63.9 | 71.5 |
| Comp. Ex. 5 - | Catalyst max temperature | 600 | 700 | 800 | |
| undoped ZrO₂ | ° C. | | | | |
| | Naphtalene conversion % | 30 | 58 | 59 | |

It will be noted that the highest conversions of naphthalene, total tar and ammonia were recorded with the La—Ce—ZrO₂. Naphthalene conversion was found to be greater than 95% for both La—Ce—ZrO₂ samples across the temperature range 600-700° C., with conversion being nearly 100% at some temperatures. Satisfactory naphthalene conversion was also found for the Ce—ZrO₂ (Example 3) material. The other samples tested were found not to be capable of at least 90% v/v conversion of naphthalene at atmospheric pressure in the temperature range 650-700° C. using a residence time of about 0.3 seconds.

Further naphthalene conversion testing was carried out on the Ce—La—ZrO₂ (Example 1) material, as well as on the La—ZrO₂ (Comparative Example 2) and La—Si—ZrO₂ (Comparative Examples 7 and 8) materials. This data is shown in FIGS. 8 and 9 respectively. The composition of the gasification gas used in this testing is shown in Table 3 below. The flow rate used was 2 l/min.

TABLE 3

| Gas component | Vol % |
|---|---|
| CO | 11.0 |
| CO₂ | 13.2 |
| H₂ | 9.6 |
| CH₄ | 5.3 |
| O₂ | 3.0 |
| N₂ | 44.4 |
| C₂H₄ | 0.877 |
| NH₃ | 0.438 |
| H₂S | 0.009 |
| Tar | 0.31369 |
| H₂O | Balance |

In FIG. 8, Comparative Example 7 has been tested before (solid line) and after (dashed line) hydrothermal treatment using 70 vol % of steam in nitrogen at 700° C. for 85 hours. Comparative Example 8 has been tested before (solid line) and after (dashed line) the same hydrothermal treatment. Comparative Example 2 has been tested before (solid line) and after (dashed line) the same hydrothermal treatment. A blank was also tested. The hydrothermal treatment is used to simulate long-term use of the catalysts in the purification of gasification gas. FIG. 8 shows that, whilst the materials of the comparative examples give relatively high initial naphthalene conversions, their activity decreases significantly after hydrothermal treatment. This indicates that, when used in the purification of gasification gas, the performance of these catalysts would decline significantly over time.

FIG. 9 shows the same analysis as FIG. 8 for two different samples of the Example 1 material. Each sample (one indicated with an “X” and one with a “□”) was tested before (solid line) and after (dashed line) the same hydrothermal treatment as was used for FIG. 8. A blank was also tested. FIG. 9 shows that the Example 1 material gave much higher naphthalene conversion than the materials of the comparative examples at temperatures below around 800° C. These conversion levels were similar for the initial samples and for the hydrothermally treated samples. This indicates that, at these temperatures, the performance of these catalysts would not deteriorate significantly. In addition, at temperatures above 800° C., the hydrothermally treated samples actually showed an improvement in naphthalene conversion over time. This suggests that, when used in the purification of gasification gas at these temperatures, the performance of these catalysts would actually improve over time.

### Experimental Testing—Ammonia Calorimery and CO₂ Adsorption

Ammonia calorimetry data was also gathered on the various samples tested. Ammonia adsorption calorimetry under flow conditions was performed on the catalysts using an indigenously developed system based on a flow-through Setaram 111 differential scanning calorimeter (DSC) and an automated gas flow and switching system, modified through the use of a mass spectrometer detector for the down-stream gas flow (Hiden HPR20) connected via a heated capillary (at 175° C.). In a typical experiment, the sample (˜50 mg) was activated at 800° C. under dried helium flow for 2 h at 5 ml min⁻¹. Following activation, the temperature was decreased to 200° C. and maintained throughout the experiment. Small 1 ml pulses of the probe gas (1% NH₃ in He) were injected at regular intervals into the carrier gas stream from a gas sampling valve also at 200° C. The concentration of ammonia downstream of the sample was monitored continuously with the mass spectrometer. The interval between pulses was chosen to ensure that the ammonia concentration in the carrier gas (including that adsorbed and then desorbed after the pulse had passed) returned to zero, and to allow the DSC baseline to re-establish itself.

The net amount of ammonia irreversibly adsorbed from each pulse was determined by comparing the MS signal during each pulse with a signal recorded during a control experiment through a blank sample tube. Net heat released for each pulse, corresponding to irreversible adsorption of ammonia, was calculated from the DSC thermal curve. From this the molar enthalpy of adsorption of ammonia (ΔH⁰ads) was obtained for the ammonia adsorbed from each successive pulse. The ΔH⁰ads values were then plotted against the amount of (irreversibly) adsorbed ammonia per gram of the catalyst, to give a ΔH⁰ads/coverage profile for each catalyst, as shown in FIG. 2.

The results are presented in FIGS. 2, 3 and 4. It will be noted that as shown in FIG. 2 the Ce—La—ZrO₂ material tested had a significantly higher initial heat of adsorption than all other compositions. The other samples tested were not capable of providing an initial heat of adsorption of ammonia of 150 kJ/mol when measured by ammonia flowing gas microcalorimetry. Furthermore it will be seen from FIG. 3 that the selection of activation temperature is important to the development of sites showing strong NH₃ adsorption. Activation at 800° C. gave the highest heats of adsorption, whilst lower activation temperatures gave correspondingly lower heats of adsorption. In addition FIG. 4 shows the importance of the selection of activation temperature for the development of sites showing strong CO₂ adsorption. FIG. 4 shows corresponding data to that of FIG. 3, except for CO₂ adsorption instead of ammonia adsorption. Again, activation at 800° C. gave the highest heats of adsorption, with these properties tailing off at lower activation temperatures. It will also be noted that the higher activation temperature the more such sites are generated.

Further ammonia calorimetry data was gathered on the Ce—La—ZrO₂ (Example 1) material, as well as the La—Si—ZrO₂ (Comparative Examples 7 and 8) materials. This data is shown in FIGS. 5, 6, 7 and 10 respectively. The Figures show the heat flow in mW over time as pulses of ammonia were passed over the material. The peaks in the graphs indicate the adsorption of ammonia onto the material. The sharp peaks shown in FIG. 5, as well as the return to a steady baseline, are an indication of quick adsorption of ammonia. In FIGS. 6 and 7 (the comparative examples), the peaks are broader and the baseline is curved, which suggests slower adsorption of ammonia as well as possible reversible adsorption so that adsorption and desorption could be occurring at the same time.

### Experimental Testing—NH₃ Temperature Programmed Desorption (TPD)

Samples produced by the methods described in Example 1 and

Comparative Examples 7 and 8 were activated by calcination at 800° C. for 4 hours under flowing dried nitrogen in a tube furnace. The samples were then cooled to 200° C. under the same atmosphere. For each sample, ammonia (1% v/v in nitrogen) was introduced in measured pulses, with downstream monitoring of ammonia using a mass spectrometer. When breakthrough is detected (ie detection of ammonia by the downstream mass spectrometer), saturation of the acid sites on the samples is assumed and a TPD experiment is performed where ammonia desorption is monitored by mass spectrometry. The desorption of ammonia from room temperature (ie 20° C.) to 550° C. was measured using a suitably calibrate mass spectrometer. It is assumed that one molecule of ammonia reacts with one acid site, and that therefore the amount of desorbed ammonia corresponds to the concentration of acid sites on the sample.

FIGS. 11-14 show the results of the TPD analysis of these samples. FIGS. 11 and 12 clearly show that the Example 1 samples gave a higher level of desorption of ammonia and over a broader range of temperatures (indicated by the broader shape of the peaks for these samples). This indicates that these samples had more acid sites (ie more ammonia absorbed, meaning more ammonia desorbed), as well as acid sites with a range of strengths (ie the ammonia desorbed at a range of temperatures, stronger acid sites requiring a higher temperature to desorb the ammonia). For the sample tested in FIG. 11, an uncalcined sample of the material of Example 1, the amount of ammonia desorbed by 550° C. was 0.042 (±0.005) mmol g⁻¹. As mentioned above, this is assumed to equal the concentration of acid sites. For the sample tested in FIG. 12, a calcined sample of the material of Example 1, the acid site concentration was 0.13 (±0.05) mmol g⁻¹. This shows the improvement in ammonia adsorption which can be achieved through calcination (and therefore conversion to a mixed oxide).

In contrast, the Comparative Examples 8 and 7 samples (shown in FIGS. 13 and 14 respectively) give lower peaks that taper off more quickly as the temperature was raised, indicating fewer acid sites and that those acid sites are weaker than for the Example 1 samples. For the sample tested in FIG. 13, a calcined sample of the material of Comparative Example 8, the acid site concentration was 0.038 (±0.005) mmol g⁻¹. For the sample tested in FIG. 14, a calcined sample of the material of Comparative Example 7, the acid site concentration was 0.062 (±0.005) mmol g⁻¹. This shows the improvement in ammonia adsorption which can be achieved with the Example 1 material.

### APPLICABILITY OF THE INVENTION

The present invention can be utilized in any process that requires gas cleanup to remove tar compounds. This includes gasification processes for gas engine power plants, particularly involving the use of gas turbine, such as IGCC processes, and gas pre-reforming prior to the reforming of hydrocarbons in the production of synthesis gas.

1. A zirconium-based mixed oxide or zirconium-based mixed hydroxide which is capable of (a) at least 90% v/v conversion of naphthalene at atmospheric pressure at a temperature in the range 600-700° C. using a residence time of about 0.3 seconds, and/or (b) providing an initial heat of adsorption of ammonia of greater than 150 kJ/mol when measured by ammonia flowing gas microcalorimetry.

2. A mixed oxide or mixed hydroxide as claimed in claim 1 which, after hydrothermal treatment in 70% v/v steam in nitrogen at 700° C. for 85 hours, is capable of at least 90% v/v conversion of naphthalene at atmospheric pressure at a temperature in the range 600-700° C. using a residence time of about 0.3 seconds.

3. A mixed oxide or mixed hydroxide as claimed in claim 1 having a total pore volume as measured by nitrogen porosimetry of at least 0.25 cm³/g but less than 1.0 cm³/g after calcination at 800° C. for 2 hours.

4. A mixed oxide or mixed hydroxide as claimed in claim 1 having a total pore volume as measured by nitrogen porosimetry of greater than 0.15 cm³/g but less than 1.0 cm³/g after calcination at 1000° C. for 2 hours.

5. A mixed oxide or mixed hydroxide as claimed in claim 1, additionally comprising cerium and/or lanthanum.

6. A mixed oxide or mixed hydroxide as claimed in claim 5 comprising:
(a) at least 60 wt % zirconia and/or zirconium hydroxide,
(b) 10-25 wt % ceria and/or cerium hydroxide, and
(c) 1-10 wt % lanthana and/or lanthanum hydroxide.

7. A mixed oxide or mixed hydroxide as claimed in claim 6 comprising:
(a) at least 70 wt % zirconia and/or zirconium hydroxide,
(b) 15-19 wt % ceria and/or cerium hydroxide, and
(c) 4-6 wt % lanthana and/or lanthanum hydroxide.

8. A mixed oxide or mixed hydroxide as claimed in claim 7 comprising:
(a) 17 wt % ceria and/or cerium hydroxide, and
(b) about 5 wt % lanthana and/or lanthanum hydroxide,
the balance being zirconia and/or zirconium hydroxide and incidental impurities.

9. A mixed oxide or mixed hydroxide as claimed in claim 1 which is capable of at least 70% v/v conversion of naphthalene at atmospheric pressure at a temperature above 700° C. using a residence time of about 0.3 seconds.

10. A method of preparing a mixed oxide or mixed hydroxide as claimed in claim 1 comprises the steps of:
(a) reacting an alkali with an aqueous solution of a zirconium salt, optionally in the presence of a cerium salt and/or a lanthanum salt, to form a zirconium hydroxide or a mixed hydroxide, and
(b) optionally calcining the zirconium hydroxide or the mixed hydroxide to form the corresponding oxide.

11. A plant for the gasification of carbonaceous materials comprising a mixed oxide or mixed hydroxide as claimed in claim 1.

12. A method for purifying gas produced from the gasification of carbonaceous materials, comprising the step of bringing the gas into contact with a mixed oxide or mixed hydroxide as claimed in claim 1.

13. The use of a mixed oxide or mixed hydroxide as claimed in claim 1 in the purification of gas produced from the gasification of carbonaceous materials.
